(19) United States
(12) Patent Application Publication
(10) Pub. No.: US 2026/0038207 A1
(43) Pub. Date: Feb. 5, 2026

(54) PREDICTION SCHEME FOR QUAD MESHES

(71) Applicant: GOOGLE LLC, Mountain View, CA (US)

(72) Inventor: Igor Vytyaz, Folsom, CA (US)

(21) Appl. No.: 19/284,822

(22) Filed: Jul. 30, 2025

Related U.S. Application Data
(60) Provisional application No. 63/677,754, filed on Jul. 31, 2024.

(51) Int. Cl. G06T 17/20; G06T 9/20

(52) U.S. Cl. CPC G06T 17/20; G06T 9/20; G06T 2210/56

(57) ABSTRACT

A method including identifying a first vertex as a vertex to be compressed, identifying a plurality of neighboring vertices as compressed vertices, predicting a position of a second vertex, the second vertex being proximate to one of the plurality of neighboring vertices, predicting a position of a third vertex, the third vertex being proximate to the first vertex, generating a correction variable based on the position of the second vertex and a position of the one of the plurality of neighboring vertices, and determining a position of the first vertex based on the position of the third vertex and the correction variable.

### CROSS REFERENCE TO RELATED APPLICATION

This application claims the benefit of U.S. Provisional Application No. 63/677,754, filed Jul. 31, 2025, the disclosure of which is incorporated herein by reference in its entirety.

### FIELD

Embodiments relate to the processing of computer graphics and geometric modeling.

### BACKGROUND

In computer graphics and geometric modeling, various mesh types can be employed to represent three-dimensional (3D) surfaces. One such type is a quad mesh, which is a polygonal mesh where each face is a quadrilateral, or a polygon with four vertices and four edges. This contrasts with triangular meshes, where all faces are triangles. The adoption of quad meshes can have advantages in certain applications due to their inherent structural properties.

### SUMMARY

Example implementations relate to processing geometric data, particularly quad meshes, to facilitate compression and decompression. A specific approach determines the position of an uncompressed vertex based on properties of nearby processed vertices, utilizing predictions and correction variables to achieve accurate spatial representations. This method can employ different prediction schemes, which may involve analyses based on edges or parallelograms inherent in the geometric structure.

In an example implementation, a mesh compression scheme can include predicting vertex positions within a quad mesh for data compression and decompression. The techniques can include identifying a vertex to be processed, locating previously processed neighboring vertices, and predicting a position for the target vertex based on these neighbors. A correction variable can be generated using a determined position and a neighboring vertex position, which then facilitates establishing the target vertex position. The approach can leverage concepts such as a Quad Tromino prediction, which can utilize edge-based or parallelogram-based calculations to facilitate accurate vertex position determinations.

In a general aspect, a device, a system, a non-transitory computer-readable medium (having stored thereon computer executable program code which can be executed on a computer system), and/or a method can perform a process with a method including identifying a first vertex as a vertex to be compressed, identifying a plurality of neighboring vertices as compressed vertices, predicting a position of a second vertex, the second vertex being proximate to one of the plurality of neighboring vertices, predicting a position of a third vertex, the third vertex being proximate to the first vertex, generating a correction variable based on the position of the second vertex and a position of the one of the plurality of neighboring vertices, and determining a position of the first vertex based on the position of the third vertex and the correction variable.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a pictorial representation of a signal flow according to at least one example implementation.

FIG. 2A illustrates an encoder/decoder system according to at least one example implementation.

FIG. 2B illustrates an encoder system according to at least one example implementation.

FIG. 2C illustrates a decoder system according to at least one example implementation.

FIGS. 3A and 3B illustrate a geometric construct in various stages of encoding according to at least one example implementation.

FIGS. 4A and 4B illustrate the geometric construct in various stages of encoding according to at least one example implementation.

FIGS. 5A and 5B illustrate predicting a position of a next point to encode within the geometric construct according to at least one example implementation.

FIG. 6 illustrates predicting a position of a next point to encode within the geometric construct according to at least one example implementation.

FIG. 7 illustrates a block diagram of a method for predicting a position of a next point to encode within the geometric construct according to at least one example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Mesh data can represent a three-dimensional surface using a collection of interconnected vertices, edges, and faces. A quad mesh can organize these faces as quadrilaterals (four-sided polygons), which can facilitate more predictable deformation and smoother rendering characteristics compared to other mesh types. When a 3D model is represented as a quad mesh can provide a geometric structure that defines the shape and contours of objects or characters within that image, enabling efficient storage, manipulation, and rendering of the visual content.

Mesh data (sometimes referred to as geometric data) can be compressed to reduce its size. In some implementations, compressing mesh data can be performed by predicting the positions of vertices. This can involve identifying a target vertex, locating nearby vertices that have already been processed, and then predicting the target vertex's location based on these known neighboring vertices. The process can include predicting additional points and generating a correction value to more accurately establish the target vertex's position. This approach can leverage different predictive techniques, including those based on edges or parallelogram relationships within the mesh. Once a vertex's position is determined, the vertex can be added to the set of previously processed vertices, becoming available for subsequent predictions.

The regular and structured nature of quad meshes, particularly when organized into a quad-dominant or pure-quad topology, can facilitate more intuitive and predictable deformation during animation and sculpting processes. This is often attributed to the ability of quads to align more naturally with the flow of surface curvature, leading to improved aesthetic qualities and reduced artifacts compared to purely triangular tessellations in certain modeling scenarios. Consequently, quad meshes are frequently selected for creating organic forms and characters in various digital content creation pipelines.

Generating a representation (e.g., compressing or encoding) as well as interpreting the representation (e.g., decompressing or decoding) of a large set of data points should include using as little space (e.g., bandwidth or memory) to store and/or communicate the representation as possible, the generating should be fast (considering processing power and situational timelines) and code complexity should be minimized (e.g., to affect the processing time).

Mesh compression is essential for efficient storage and transmission of 3D data. Accurate prediction schemes for vertex attributes, such as positions, help to achieve high compression rates. Some compression libraries support meshes with triangular faces only and implement a number of prediction schemes for triangular meshes. Quad meshes are also popular, for example, quad meshes can be commonly exported by 3D content creation tools. At least one technical problem is that compression libraries can include prediction schemes configured to triangulate quad meshes and apply prediction schemes developed for triangular faces. Compression schemes configured to triangulate quad meshes and apply prediction schemes developed for triangular faces can be inefficient (e.g., do not compress sufficiently, and the like). Accordingly, at least one technical solution can be a prediction scheme(s) developed specifically for quad meshes. At least one technical effect of these prediction schemes can be to exploit the quad connectivity and vertex attributes without triangulation and deliver more accurate predictions and higher compression rates compared to the best prediction schemes available for triangular meshes.

In some implementations, a vertex is a fundamental point in a polygonal mesh, such as a quad mesh or a triangular mesh. In some implementations, in a quad mesh, a vertex is a point connected to four edges, and four vertices collectively form a quadrilateral face. In some implementations, each vertex is associated with a position in a three-dimensional space, and its position is an attribute that can be processed, compressed, predicted based on neighboring vertices, and subsequently reconstructed during mesh data compression and decompression operations

In some implementations, compression can refer to a state of data or a data unit (such as geometric data or a vertex) that has undergone a transformation process (e.g., an encoding or a prediction scheme) to reduce its overall size, thereby enabling more efficient storage, transmission, or communication by utilizing less bandwidth or memory. In some implementations, in the context of a mesh vertex, a vertex is considered compressed once its position has been determined and processed by the compression scheme, subsequently rendering it available as a previously compressed vertex for use in predicting the positions of other uncompressed vertices. In some implementations, this reduced-size form may include representations such as predictive encodings (e.g., offsets or deltas) or entropy encoded values, which can be reversed by a corresponding decompression process to reconstruct the original data.

In some implementations, predicting a position of a vertex, within a mesh compression and/or decompression scheme, can include estimating or forecasting the unknown spatial coordinates of a target vertex (such as a second, third, or fourth vertex, or the first vertex itself) by leveraging the known attributes (e.g., positions) of other, already processed (e.g., compressed or decoded) and spatially related vertices (e.g., neighboring vertices) within the mesh. In some implementations, this estimation process can involve employing specific geometric prediction schemes, such as Quad Tromino prediction, which can utilize calculations based on topological relationships (e.g., edges, parallelograms) to determine an estimated position. In some implementations, the result of predicting can include an estimated position that, when compared to the actual position, allows for the generation of a compact representation (e.g., an offset or correction variable) for efficient data compression.

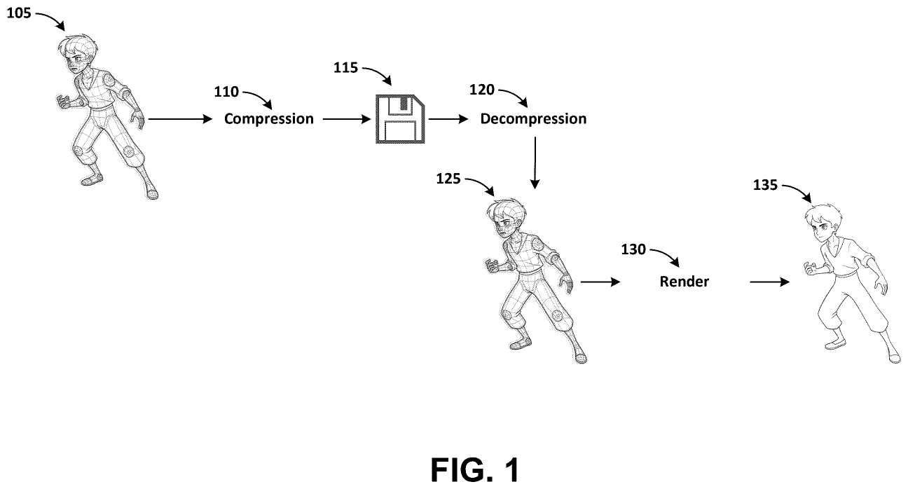

FIG. 1 illustrates a pictorial representation of a signal flow according to at least one example implementation. FIG. 1 illustrates a process flow that transforms input mesh data representing an animated character, through compression and decompression operations, to generate reconstructed mesh data that can then be rendered as an image of the animated character. As shown in FIG. 1, the signal flow can include input mesh data 105 (illustrated as an animated character), a compression operation 110, compressed data 115, a decompression operation 120, reconstructed mesh data 125 (illustrated as an animated character), a rendering operation 130, and an image 135 (illustrated as an animated character). In some implementations input mesh data 105 and reconstructed mesh data 125 can be quad mesh data.

In some implementations, a quad mesh (referred to as geometric data when in a computer data format) can be a type of mesh used in computer graphics and geometric modeling where the faces of the mesh are quadrilaterals (e.g., four-sided polygons). By contrast, in a triangular mesh the faces are triangles. For example, each face in a quad mesh has four edges and four vertices whereas each face in a triangular mesh has three edges and three vertices. In some implementations, a quad mesh can provide better edge flow than triangular meshes. Edge flow can refer to how the edges of the polygons align and follow the contours of a surface.

As an example, a quad mesh can be beneficial (as compared to a triangular mesh) for animation and deformation, as a quad mesh can allow for more natural-looking bends and stretches. In some implementations, a quad mesh can be more suited for subdivision surfacing, a technique used to create smooth, high-resolution surfaces from a lower-resolution base mesh. When a quad is subdivided, the quad mesh can produce four smaller quads, maintaining the quad-only structure. This property can make a quad mesh more advantageous for organic modeling. In some implementations, a quad mesh can be easier to UV unwrap (the process of projecting a 3D model's surface onto a 2D plane for texturing) compared to triangular meshes, especially for surfaces with clear directional flow. In some implementations, a quad mesh can be deformed more predictably and smoothly during animation, reducing undesirable pinching or creasing artifacts. This is due to a quad mesh having a regular structure and predictable edge flow.

Input mesh data 105 can be of a size (e.g., number of bits, number of bytes, and the like) that precludes storing or communicating input mesh data 105 without further processing. Accordingly, compression 110 can be used to generate compressed data 115 based on input mesh data 105. Compressed data 115 can then be stored or communicated. As mentioned above, input mesh data 105 can be quad mesh data. Therefore, in some implementations, compression 110 can use a compression scheme specifically for quad meshes. The quad mesh compression scheme can use a prediction scheme that takes advantage of the quad connectivity and vertex attributes of a quad mesh.

The prediction scheme can be configured to identify a first vertex of the quad mesh as a vertex to be compressed, the first vertex can be a vertex that has not been compressed. A plurality of neighboring vertices of the first vertex can be compressed vertices. Therefore, neighboring vertices can be identified as compressed vertices. The prediction scheme can then predict a position of a second vertex, the second vertex can be proximate to one (or more than one) of the plurality of neighboring vertices. The prediction scheme can then predict a position of a third vertex, the third vertex can be proximate to (e.g., close to, within a predefined range of, and the like) the first vertex. The prediction scheme can then generate a correction variable based on the position of the second vertex and a position of the one of the plurality of neighboring vertices. The prediction scheme can then determine a position of the first vertex based on the position of the third vertex and the correction variable. The quad mesh compression scheme can include compressing mesh data 105 (e.g., as geometric data) which can include compressing the first vertex.

After receiving the communicated compressed data 115 and/or retrieving the compressed data 115 from a memory, the reconstructed mesh data 125 can be generated by decompression 120 based on compressed data 115. Reconstructed mesh data 125 can be rendered as image 135 by render 130.

Decompressing mesh data (decompression 120) can include reversing the compression process, which can leverage various techniques depending on how the mesh data was initially compressed. For example, some compression methods might exploit the connectivity and geometric regularity inherent in quad meshes. A common approach to decompressing mesh data involves reading a compressed bitstream, which may contain information such as vertex positions, normal vectors, texture coordinates, and connectivity data. The decompression process could entail decoding predictive encodings, where the position of a subsequent vertex is represented as an offset or delta from a previously decoded vertex. Additionally, connectivity information, such as the sequence of vertices forming quadrilateral faces, may be reconstructed by interpreting symbolic representations or indices that were compactly encoded.

Rendering mesh data (render 130) can include a multi-stage process that transforms the abstract geometric information into a visible image. This process can begin with the mesh data, which may include vertex positions, normal vectors, texture coordinates, and connectivity information (defining the faces, such as quadrilaterals). A graphics processing unit (GPU) can be used to perform the rendering operations. The initial stage can include vertex processing, where a vertex shader program, executed on the GPU, transforms the vertex positions from a model's local coordinate system into a global coordinate system, and subsequently projects them onto a two-dimensional viewing plane. This transformation can include lighting calculations, where the normal vectors of the vertices are used in conjunction with light sources to determine how light interacts with the surface. Texture coordinates can also be used to map colors from a texture onto mesh surface during rendering.

Following vertex processing, the transformed vertices can be assembled into primitive geometric shapes, such as triangles or quadrilaterals, based on connectivity data. A rasterization stage can then determine which pixels on the screen are covered by these primitives. For each covered pixel, a fragment shader program can be executed. The fragment shader can perform various operations, such as sampling a texture using the interpolated texture coordinates, applying lighting calculations based on interpolated normal vectors, and determining the final color of the pixel. The depth of each pixel can be computed and stored in a depth buffer to ensure that closer objects correctly occlude more distant ones. The results from the fragment shader are then written to a frame buffer, which represents the final image (image 135) to be displayed. Compression 110 and decompression 120 are described in more detail below.

In some implementations, proximate can refer to a spatial relationship where a first element is in close proximity to a second element. In some implementations, proximate can specifically include the concept that the first element is located within a predefined range of the second element.

In some implementations, a correction variable is a quantifiable value generated within a mesh compression or decompression scheme. In some implementations, a correction variable is determined based on the known positions of at least one predicted vertex (e.g., a second or fourth vertex) and its corresponding neighboring vertex. In some implementations, the purpose of a correction variable can be to facilitate or refine the determination of the accurate position of a target vertex (e.g., a first vertex) by being combined (e.g., added) with a predicted position of that target vertex or a related vertex (e.g., a third vertex), thereby adjusting the prediction to achieve a more precise final position.

In some implementations, edges are linear segments that form the boundaries of faces in a polygonal mesh, such as a quad mesh or a triangular mesh, connecting its vertices. In some implementations, in a quad mesh, a face is a quadrilateral formed by four edges, and a vertex is typically connected to four edges. In some implementations, edges define the connectivity within the mesh and contribute to the edge flow, which describes how the edges align and follow the contours of a surface. Furthermore, in some implementations, edges represent fundamental geometric relationships used as a basis for calculations in prediction schemes for mesh compression.

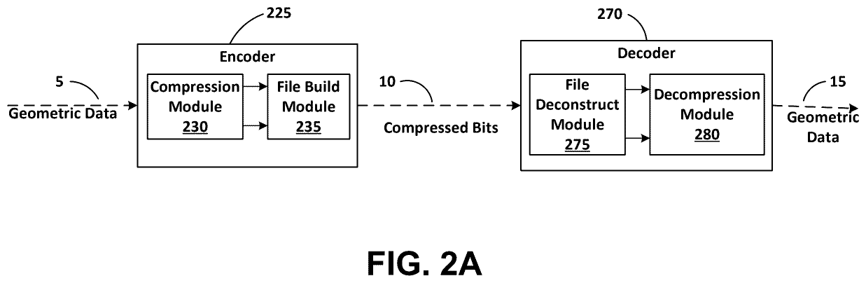

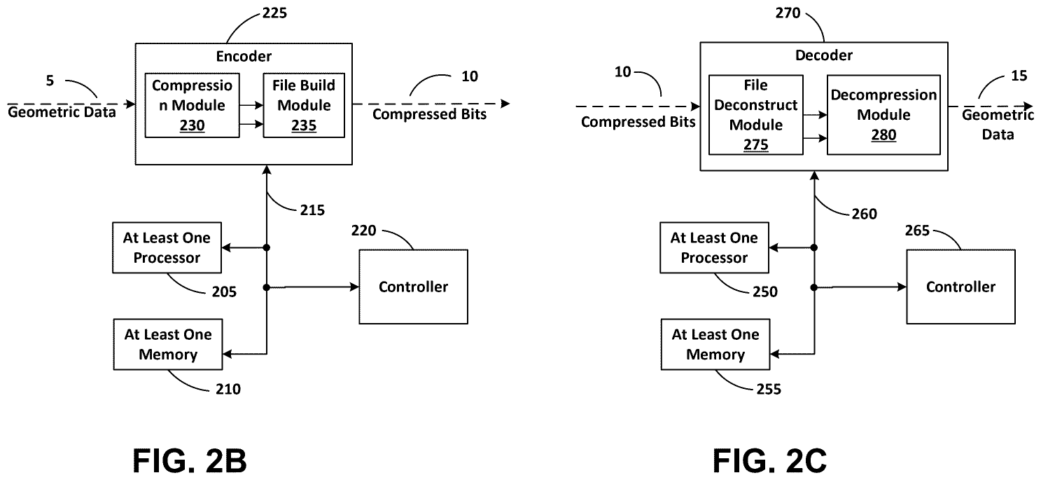

FIG. 2A illustrates an encoder/decoder system according to at least one example implementation. As shown in FIG. 2A, the encoder/decoder system can include an encoder 225 and a decoder 270. The encoder 225 can include a compression module 230 and a file build module 235. The decoder 270 can include a file deconstruct module 275 and a decompression module 280. The encoder 225 can be configured to generate compressed bits 10 based on geometric data 5. The decoder 270 can be configured to generate geometric data 15 based on compressed bits 10. Geometric data 15 can be reconstructed geometric data corresponding to (representing, associated with, and the like) geometric data 5.

The compression module 230 can be configured to compress geometric data using a prediction scheme configured to predict vertices in a quad mesh(es). For example, compression module 230 can include a memory configured to store a plurality of compression schemes. At least one of the compression schemes can include a prediction scheme configured to predict vertices in a quad mesh(es). Compression module 230 can be configured to communicate a compressed mesh and an indication of the compression scheme and/or the prediction scheme to the file build module 235.

The file build module 235 can be configured to generate a file based on a plurality of entropy encoded values representing compressed geometric data 5 and the compression scheme and/or the prediction scheme used to compress geometric data 5. The generated file may include a header or other metadata including information about the geometric construct (e.g., point cloud, mesh, and the like), the compression scheme and/or the prediction scheme (e.g., variables associated with the compression module 230), and the like. The generated file may be stored in a local memory and/or communicated to another device (e.g., a device separate from and communicatively coupled to the device that encoded the point cloud data) as the compressed bits 10.

The file deconstruct module 275 can be configured to receive a file including compressed bits 10 representing a stream of data corresponding to a geometric construct (e.g., point cloud, mesh, and the like). The compressed bits having been previously compressed using a prediction scheme configured to predict vertices in a quad mesh(es). The file deconstruct module 275 can be configured to determine the prediction scheme used to compress a geometric construct and a plurality of entropy encoded values representing compressed geometric data 5. The file deconstruct module 275 can be configured to communicate the prediction scheme and the plurality of entropy encoded values representing compressed geometric data 5 to the decompression module 280. The decompression module 280 can be configured to decompress the plurality of entropy encoded values representing compressed geometric data 5 using the prediction scheme. The decompressed data can be geometric data 15 or reconstructed geometric data corresponding to (representing, associated with, and the like) geometric data 5.

FIG. 2B illustrates an encoder system according to at least one example implementation. In the example of FIG. 2B, an encoder system may be at least one computing device and should be understood to represent virtually any computing device configured to perform the methods described herein. As such, the encoder system may be understood to include various standard components which may be utilized to implement the techniques described herein, or different or future versions thereof. By way of example, the encoder system is illustrated as including at least one processor 205, as well as at least one memory 210 (e.g., a computer readable storage medium).

Thus, as may be appreciated, the at least one processor 205 may be utilized to execute instructions stored on the at least one memory 210, so as to thereby implement the various features and functions described herein, or additional or alternative features and functions. Of course, the at least one processor 205 and the at least one memory 210 may be utilized for various other purposes. In particular, the at least one memory 210 may be understood to represent an example of various types of memory and related hardware and software which might be used to implement any one of the modules described herein.

As shown in FIG. 2B, the encoder system includes the at least one processor 205, the at least one memory 210, a controller 220, and an encoder 225. The at least one processor 205, the at least one memory 210, the controller 220, and the encoder 225 are communicatively coupled via bus 215.

The at least one processor 205 may be configured to execute computer instructions associated with the controller 220 and/or the encoder 225. The at least one processor 205 may be a shared resource. For example, the encoder system may be an element of a larger system (e.g., a 2D or 3D scanner). Therefore, the at least one processor 205 may be configured to execute computer instructions associated with other elements (e.g., controller laser scanner position or movement) within the larger system.

The at least one memory 210 may be configured to store data and/or information associated with the encoder system. For example, the at least one memory 210 may be configured to store buffers including, for example, buffers storing geometric data, portions of the geometric data, positions of data points in the geometric data, a number of data points associated with a portion of the geometric data, and/or the like. For example, the at least one memory 210 may be configured to store buffers including, for example, data associated with a geometric construct (e.g., a mesh, a point cloud, and the like).

The controller 220 may be configured to generate various control signals and communicate the control signals to various blocks in encoder system. The controller 220 may be configured to generate the control signals in accordance with the methods described above. The controller 220 may be configured to control the encoder 225 to encode data associated with a geometric construct according to example embodiments as described herein. For example, the controller 220 may generate and communicate a control signal indicating a compression scheme in compression module 230. For example, the controller 220 may generate and communicate a control signal indicating the prediction scheme configured to predict vertices in a quad mesh(es).

FIG. 2C illustrates a decoder system according to at least one example implementation. In the example of FIG. 2C, a decoder system may be at least one computing device and should be understood to represent virtually any computing device configured to perform the methods described herein. As such, the decoder system may be understood to include various standard components which may be utilized to implement the techniques described herein, or different or future versions thereof. By way of example, the decoder system is illustrated as including at least one processor 250, as well as at least one memory 255 (e.g., a computer readable storage medium).

As shown in FIG. 2C, the decoder system includes the at least one processor 250, the at least one memory 255, a controller 265, and a decoder 270. The at least one processor 250, the at least one memory 255, the controller 265, and the decoder 270 are communicatively coupled via bus 260.

The at least one processor 250 may be utilized to execute instructions stored on the at least one memory 255, so as to thereby implement the various features and functions described herein, or additional or alternative features and functions. Of course, the at least one processor 250 and the at least one memory 255 may be utilized for various other purposes. In particular, the at least one memory 255 may be understood to represent an example of various types of memory and related hardware and software which might be used to implement any one of the modules described herein. According to example embodiments, the encoder system of FIG. 2A and the decoder system FIG. 2B may be included in a same larger system. Further, the at least one processor 250 and the at least one processor 205 may be a same at least one processor and the at least one memory 255 and the at least one memory 210 may be a same at least one memory. Still further, the controller 265 and the controller 220 may be a same controller.

The at least one processor 250 may be configured to execute computer instructions associated with the controller 265 and/or the decoder 270. The at least one processor 250 may be a shared resource. For example, the decoder system may be an element of a larger system (e.g., a mobile device). Therefore, the at least one processor 250 may be configured to execute computer instructions associated with other elements (e.g., web browsing or wireless communication) within the larger system.

The at least one memory 255 may be configured to store data and/or information associated with the decoder system. For example, the at least one memory 255 may be configured to store buffers including, for example, buffers storing geometric data, portions of the geometric data, positions of data points in the geometric data, a number of data points associated with a portion of the geometric data, and/or the like. For example, the at least one memory 255 may be configured to store buffers including, for example, data associated with a geometric construct.

The controller 265 may be configured to generate various control signals and communicate the control signals to various blocks in the decoder system. The controller 265 may be configured to generate the control signals in accordance with the methods described above. The controller 265 may be configured to control the decoder 270 to decode data associated with a geometric construct according to example embodiments as described above. For example, the controller 265 may generate and communicate a control signal indicating a prediction scheme configured to predict vertices in a quad mesh(es).

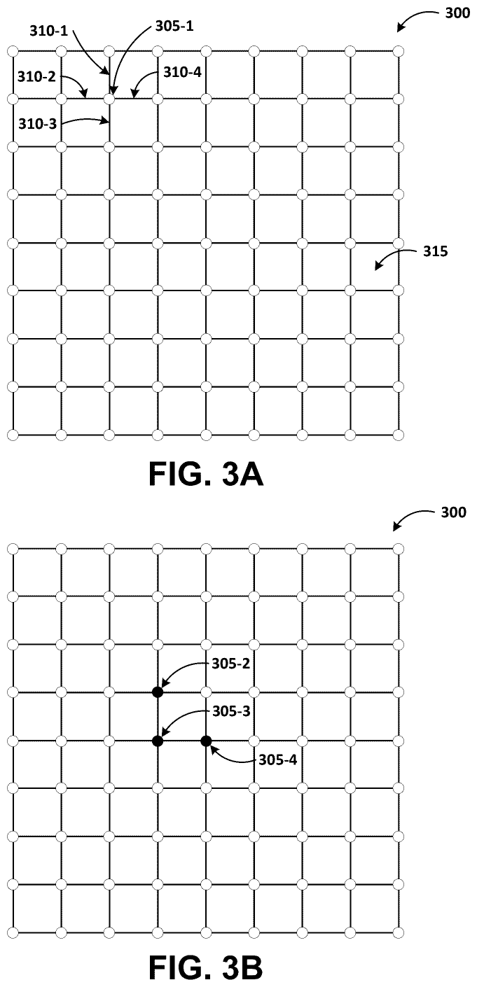

FIGS. 3A and 3B illustrate a geometric construct in various stages of encoding according to at least one example implementation. FIG. 3A illustrates a geometric construct 300 (e.g., a mesh, a point cloud, and the like) as a quad mesh. In FIG. 3A, no vertex has been compressed. In a quad mesh (or grid) each vertex can be connected to four edges. For example, as shown in FIG. 2A, a vertex 305-1 is connected to edge 310-1, edge 310-2, edge 310-3, and edge 310-4. Further, four (4) vertices can form a face (e.g., face 315).

In FIG. 3B, some vertices have been compressed. For example, vertex 305-2 is compressed, vertex 305-3 is compressed, and vertex 305-4 is compressed. In FIG. 3B any prediction scheme could have been used to compress vertex 305-2, vertex 305-3, and vertex 305-4. Example implementations include two prediction schemes used for computing a predicted vertex value. A first prediction scheme is based on edges and a second prediction scheme is based on parallelograms. Both prediction schemes can use a Quad Tromino prediction neighborhood of nearby vertices. Both prediction schemes (e.g., via parallelograms and via edges) can lead to the same mathematical expression to predict vertex position. Accordingly, there can be one mathematical expression and two geometric interpretations (e.g., via parallelograms and via edges) that help visualize that expression.

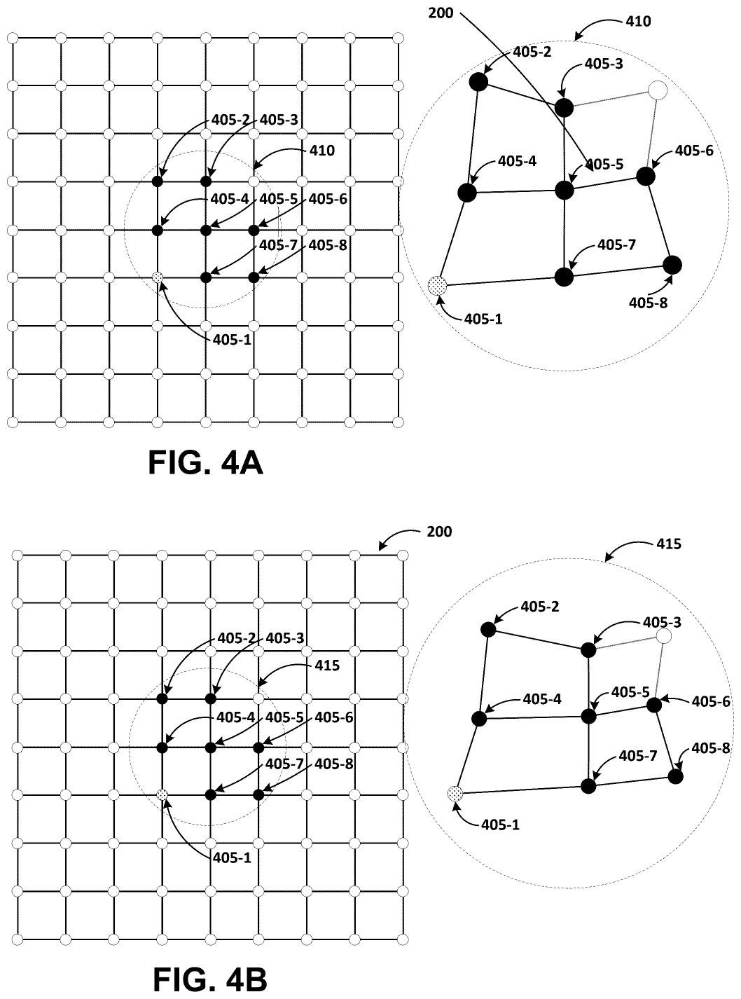

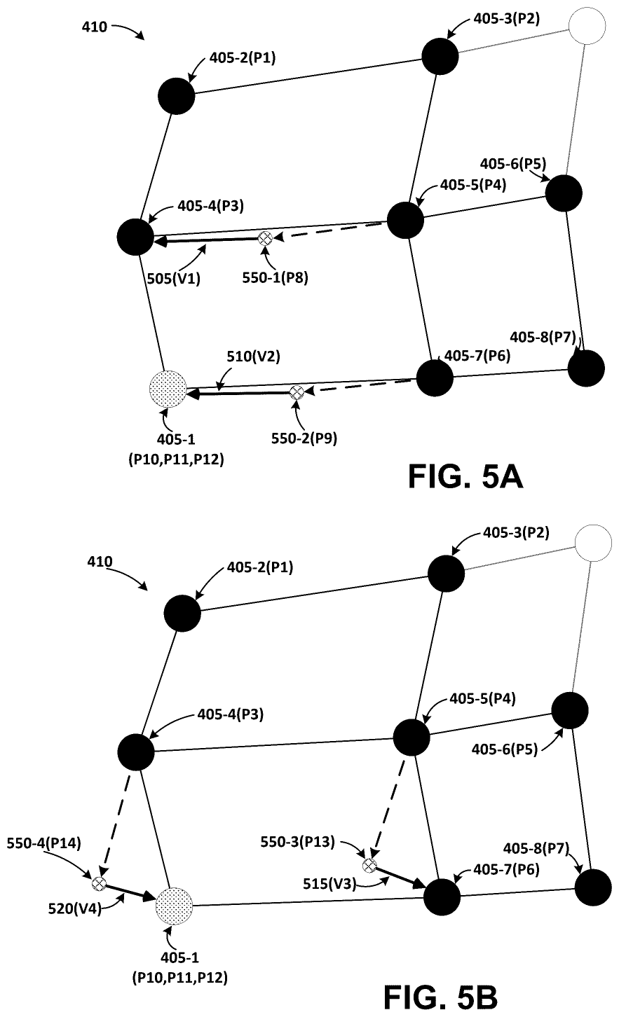

Quad Tromino prediction can be quad (e.g., quadrilateral face) or quad based prediction. For example, Quad Tromino can use three quads or three quadrilateral faces. The three quads can be in the neighborhood of the vertices. For example, as shown in FIGS. 4A-5B, the neighborhood quads can be L-shaped. Although the example neighborhood includes tree quads in an L-shape, other numbers of quads in other shapes are within the scope of this disclosure.

Some implementations describe a Quad Tromino prediction neighborhood using seven (7) nearby vertices. The seven (7) nearby vertices must be previously compressed vertices. The example prediction schemes can model the curvature and spacing of the vertical and horizontal grid lines to generate accurate vertex location predictions. In FIGS. 3A and 3B there are less than seven (7) compressed nearby vertices. Therefore, Quad Tromino prediction may not be used. However, in FIGS. 4A and 4B a vertex to be compressed can have, at least, seven (7) compressed nearby vertices.

In some implementations, a primary set of previously compressed neighboring vertices may be identified as a basis for an initial prediction of a vertex's position. This initial prediction can leverage the established relationships and known positions of these neighbors or immediate neighbors, for example, by applying a Quad Tromino prediction based on edges or parallelograms. This early prediction provides a computationally efficient first estimate, which can then be refined through subsequent steps or by incorporating additional information.

In some implementations, an additional set of previously processed neighboring vertices, distinct from the primary set used for an initial position determination, could be identified and leveraged to further modify or refine the determined position of the first vertex, to provide alternative predictions, or to validate the initial position. For example, a multi-stage prediction process could employ the primary set for a preliminary estimation and then incorporate the additional set to generate a second, independently derived position for the first vertex. This second position could then be averaged with the first or utilized as a basis for applying a further correction variable. This could involve expanding the neighborhood, considered in a Quad Tromino prediction to include a broader collection of previously compressed vertices, thereby enhancing the robustness or precision of the determined position.

In some implementations, neighboring (as in neighboring vertices) refers to a plurality of vertices in a mesh that are spatially located in proximity to a target vertex to be processed, and which have already been processed (i.e., compressed) by the mesh compression scheme. In some implementations, these previously compressed neighboring vertices serve as known reference points from which the position of the target (uncompressed) vertex can be predicted, and their attributes (e.g., positions) are utilized in prediction schemes, such as Quad Tromino prediction, for subsequent vertex compression operations.

FIGS. 4A and 4B illustrate the geometric construct in a stage of encoding according to at least one example implementation. In FIG. 4A vertex 405-2, vertex 405-3, vertex 405-4, vertex 405-5, vertex 405-6, vertex 405-7, and vertex 405-8 are indicated as previously compressed vertices. Further, vertex 405-1 is indicated as a vertex to be compressed. Grouping 410 illustrates the nearby vertices in FIG. 4A and grouping 415 illustrates the nearby vertices in FIG. 3B. As shown by grouping 410 and grouping 415, vertex 405-1 has seven (7) compressed nearby vertices (or compressed neighbor vertices). Accordingly, a Quad Tromino prediction may be used to predict a location of vertex 405-1. FIGS. 5A and 5B illustrate a first prediction scheme for predicting a location of vertex 405-1 using a Quad Tromino prediction.

FIGS. 5A and 5B illustrate predicting a position of a next point to encode within the geometric construct according to at least one example implementation. FIGS. 5A and 5B are used to illustrate a Quad Tromino prediction on grouping 410 using the first prediction scheme which is based on edges. In FIG. 5A, line P6-P9 should be the same length and direction as line P7-P6, line P4-P8 should be the same length and direction as line P5-P4, and error vector V2 should be the same length and direction as error vector V1.

Referring to FIG. 5A, in a first step, a position of two (2) calculated vertex positions are determined. For example, a first calculated vertex 550-1 position P8 can be determined as two (2) times the position P4 of vertex 405-5 minus the position P5 of vertex 405-6. This calculation can be rewritten as:

$$P 8 = 2 \times P 4 - P 5$$

Next, an error vector V1 can be determined as a vector represented by solid line 505. Vector V1 can be calculated as the position P3 of vertex 405-4 minus the position P8 of calculated vertex 550-1. This calculation can be rewritten as:

$$V 1 = P 3 - P 8$$

Next, a second calculated vertex 550-2 position P9 can be determined as two (2) times the position P6 of vertex 405-7 minus the position P7 of vertex 405-8. This calculation can be rewritten as:

$$P 9 = 2 \times P 6 - P 7$$

The position of vertex 405-4 is known. However, the position of vertex 405-1 (the vertex to be compressed) is unknown. In some implementations, an error vector V2 can be determined as a vector represented by solid line 510. In some implementations, an error vector V2 can be equal to error vector V1 or V2=V1. For some vertices V2=V1 which can generate a precise prediction. However, for some vertices V1 and V2 are not equal but close enough to each other. Therefore, the prediction can be used and can be better than any known alternative. Therefore, the position P10 of vertex 405-1 can be predicted as the position P9 of calculated vertex 550-2 plus error vector V1. This calculation can be rewritten as:

$$P 10 = P 9 + V 1$$

Referring to FIG. 5B, a similar process can be followed to predict the position P11 of vertex 405-1. In FIG. 5B, line P3-P14 should be the same length and direction as line P1-P3, line P4-P13 should be the same length and direction as line P2-P4, and error vector V4 should be the same length and direction as error vector V3. In a first step, a position of two (2) calculated vertex positions are determined. For example, a first calculated vertex 550-3 position P13 can be determined as two (2) times the position P4 of vertex 405-5 minus the position P2 of vertex 405-3. This calculation can be rewritten as:

$$P 13 = 2 \times P 4 - P 2$$

Next, an error vector V3 can be determined as a vector represented by solid line 515. Vector V3 can be calculated as the position P6 of vertex 405-7 minus the position P13 of calculated vertex 550-3. This calculation can be rewritten as:

$$V 3 = P 6 - P 13$$

Next, a second calculated vertex 550-4 position P14 can be determined as two (2) times the position P3 of vertex 405-4 minus the position P1 of vertex 405-2. This calculation can be rewritten as:

$$P 14 = 2 \times P 3 - P 1$$

The position of vertex 405-7 is known. However, the position of vertex 405-1 (the vertex to be compressed) is unknown. In some implementations, an error vector V4 can be determined as a vector represented by solid line 520. In some implementations, an error vector V4 can be equal to error vector V3 or V4=V3. Therefore, the position P11 of vertex 405-1 can be predicted as the position P14 of

calculated vertex 550-4 plus error vector V3. This calculation can be rewritten as:

$$P 11 = P 14 + V 3$$

A final position P12 of vertex 405-1 can be predicted as an average of the position P10 of vertex 405-1 predicted using the steps of FIG. 5A and the position P11 of vertex 405-1 predicted using the steps of FIG. 5B. This calculation can be rewritten as:

$$P 12 = ( P 10 + P 11 ) / 2$$

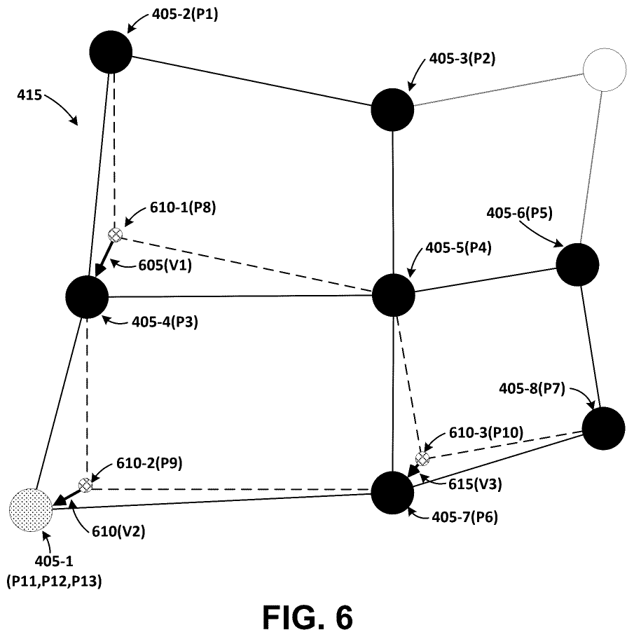

FIG. 6 illustrates predicting a position of a next point to encode within the geometric construct according to at least one example implementation. FIG. 6 is used to illustrate a Quad Tromino prediction on grouping 415 using the second prediction scheme which is based on parallelograms. A position of three (3) calculated vertex positions are determined. For example, a first calculated vertex 610-1 position P8 can be determined as the position P1 of vertex 405-2 plus the position P4 of vertex 405-5 minus the position P2 of vertex 405-3. This calculation can be rewritten as:

$$P 8 = P 1 + P 4 - P 2$$

Next, an error vector V1 can be determined as a vector represented by solid line 605. Vector V1 can be calculated as the position P3 of vertex 405-4 minus the position P8 of calculated vertex 610-1.

$$V 1 = P 3 - P 8$$

Next, a second calculated vertex 610-2 position P9 can be determined as the position P3 of vertex 405-4 plus the position P6 of vertex 405-7 minus the position P4 of vertex 405-5. This calculation can be rewritten as:

$$P 9 = P 3 + P 6 - P 4$$

The position of vertex 405-4 is known. However, the position of vertex 405-1 (the vertex to be compressed) is unknown. In some implementations, an error vector V2 can be determined as a vector represented by solid line 610. In some implementations, an error vector V2 can be equal to error vector V1 or V2=V1. Therefore, the position P11 of vertex 405-1 can be predicted as the position P9 of calculated vertex 610-2 plus error vector V1. This calculation can be rewritten as:

$$P 11 = P 9 + V 1$$

Next, a third calculated vertex 610-3 position P10 can be determined as the position P4 of vertex 405-5 plus the position P7 of vertex 405-8 minus the position P5 of vertex 405-6. This calculation can be rewritten as:

$$P 10 = P 4 + P 7 - P 5$$

Next, an error vector V3 can be determined as a vector represented by solid line 615. Vector V3 can be calculated as the position P6 of vertex 405-7 minus the position P10 of calculated vertex 610-3. This calculation can be rewritten as:

$$V 3 = P 6 - P 10$$

Position P9 of the second calculated vertex 610-2 was calculated above. The position of vertex 405-7 is known. However, the position of vertex 405-1 (the vertex to be compressed) is unknown. In some implementations, an error vector V3 can be determined as a vector represented by solid line 615. In some implementations, an error vector V2 can be equal to error vector V3 or V2=V3. Therefore, the position P12 of vertex 405-1 can be predicted as the position P9 of calculated vertex 610-2 plus error vector V3. This calculation can be rewritten as:

$$P 12 = P 9 + V 3$$

A final position P13 of vertex 405-1 can be predicted as an average of the predicted position P11 of vertex 405-1 and the predicted position P12 of vertex 405-1. This calculation can be rewritten as:

$$P 13 = ( P 11 + P 12 ) / 2$$

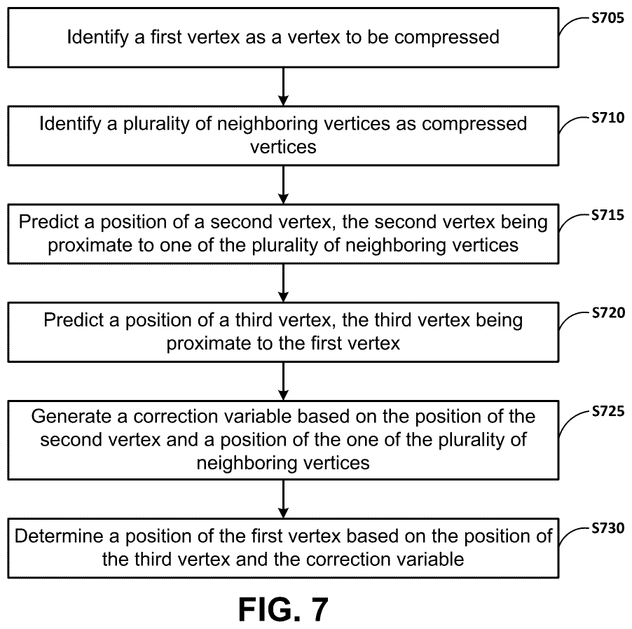

FIG. 7 illustrates a block diagram of a method for predicting a position of a next point to encode within the geometric construct according to at least one example implementation.

Example 1. FIG. 7 is a block diagram of a method for predicting a position of a next point to encode within the geometric construct according to an example implementation. As shown in FIG. 7, in step S705 identify a first vertex as a vertex to be compressed. In step S710 identify a plurality of neighboring vertices as compressed vertices. In step S715 predict a position of a second vertex, the second vertex being proximate to one of the plurality of neighboring vertices. In step S720 predict a position of a third vertex, the third vertex being proximate to the first vertex. In step S725 generate a correction variable based on the position of the second vertex and a position of the one of the plurality of neighboring vertices. In step S730 determine a position of the first vertex based on the position of the third vertex and the correction variable.

Example 2. The method of Example 1, wherein the position of the first vertex can be prediction based on edges of geometric data being compressed. For example, determination of the position of the first vertex can be performed using a prediction that considers the edges of the geometric data being compressed. This approach can leverage the connectivity defined by the edges of the mesh, enabling a scheme to estimate the location of the first vertex based on the spatial relationships and configurations of its already processed neighboring vertices.

Example 3. The method of Example 1, wherein the position of the first vertex can be determined using a Quad Tromino prediction based on edges. For example, the position of a first vertex can be determined using a Quad Tromino prediction based on edges by leveraging the defined connectivity of the geometric data. This approach considers specific spatial relationships between the first vertex and its previously processed neighboring vertices, establishing a predictive framework that utilizes the linear extensions or directional aspects inherent in the mesh's edge structure to estimate the first vertex's location.

Example 4. The method of Example 1, wherein the position of the first vertex can be prediction based on parallelograms of geometric data being compressed. For example, the position of the first vertex can be prediction based on parallelograms of geometric data being compressed by leveraging a parallelogram-based prediction scheme, such as a Quad Tromino prediction based on parallelograms. This can involve determining a calculated vertex position based on a parallelogram relationship formed by previously compressed neighboring vertices, and then using this calculated position to predict the location of the first vertex. For example, a correction variable can be generated, enabling the determination of the first vertex's position by considering its proximity to a third predicted vertex and the calculated correction.

Example 5. The method of Example 1, wherein the position of the first vertex is determined using a Quad Tromino prediction based on parallelograms. For example, the position of the first vertex can be determined using a Quad Tromino prediction based on parallelograms, which can involve defining specific geometric relationships between the first vertex and its previously processed neighboring vertices. This prediction scheme can leverage the parallelogram properties formed by these known vertices to estimate the location of the first vertex, enabling a precise determination by considering the correction variable.

Example 6. The method of Example 1 can further include receiving geometric data including a quad mesh.

Example 7. The method of Example 1 can further include predicting a position of a fourth vertex, the fourth vertex being proximate to a second one of the plurality of neighboring vertices, generating a second correction variable based on the position of the fourth vertex and a position of the second one of the plurality of neighboring vertices, and determining a second position of the first vertex based on the position of the third vertex and the second correction variable.

Example 8. The method of Example 7 can further include determining a third position of the first vertex based on the position of the first vertex and the second position of the first vertex.

Example 9. The method of Example 1 can further include compressing geometric data including compressing the first vertex, wherein the first vertex is added to the plurality of neighboring vertices. For example, an encoder can be configured to process a quad mesh by identifying an uncompressed first vertex and a plurality of previously compressed neighboring vertices. A prediction scheme may then determine a position of the first vertex based on these neighboring vertices and other predicted points. Once the first vertex position is determined and the vertex is compressed, it can be considered a previously compressed vertex, thus becoming available for use as a neighboring vertex for subsequent vertex compression operations.

Example 10. The method of Example 1 can further include modifying the determined position of the first vertex based on a geometric property of at least one of the plurality of neighboring vertices, wherein the geometric property includes a curvature or a spacing of grid lines. For example, the determined position of the first vertex can be further modified by considering a geometric property of at least one of the plurality of neighboring vertices, such a geometric property can include a curvature or a spacing of grid lines of the quad mesh. This modification can refine the initial position determination by incorporating contextual information derived from the geometric characteristics of the surrounding processed vertices. This approach allows for adjustments that account for local variations in the mesh, leading to a more accurate representation of the first vertex's position.

Example 11. The method of Example 1 can further include modifying the determined position of the first vertex by applying the correction variable.

Example 12. The method of Example 1 can further include modifying the determined position of the first vertex based on an average of multiple predictions derived from different neighboring vertex combinations. For example, the determined position of the first vertex can be further modified by considering an average derived from multiple predictions, where each prediction originates from a different combination of neighboring vertices. This averaging approach can enhance the accuracy and robustness of the determined position by integrating diverse predictive insights from the surrounding processed mesh data, thereby mitigating potential inaccuracies that might arise from reliance on a single prediction path.

Example 13. The method of Example 1 can further include modifying the determined position of the first vertex based on an additional set of neighboring vertices, where the additional set of neighboring vertices includes previously processed vertices not utilized in the determination of the position of the first vertex. For example, the determined position of the first vertex can be further modified by considering an additional set of neighboring vertices, where the additional set includes previously processed vertices that were not utilized in the initial determination of the position of the first vertex. This can involve, for example, leveraging a broader collection of previously compressed vertices to refine the initial position, generate alternative predictions, or provide a basis for applying a further correction variable to enhance the accuracy or robustness of the determined position.

Example 14. The method of Example 1, wherein determining the position of the first vertex can include averaging a plurality of predicted positions. For example, the determination of the position of the first vertex can include averaging a plurality of predicted positions. For example, as described in connection with FIG. 5A, a first predicted position (P10) for the first vertex can be determined by applying a prediction scheme to a first set of neighboring vertices. Similarly, as described in connection with FIG. 5B, a second predicted position (P11) for the first vertex can be determined by applying the prediction scheme to a second set of neighboring vertices, distinct from the first set. The final determined position (P12) of the first vertex can then be established by averaging these multiple predicted positions, which can enhance the accuracy and robustness of the determined position by integrating diverse predictive insights derived from the surrounding processed mesh data.

Example 15. A method can include any combination of one or more of Example 1 to Example 14.

Example 16. A non-transitory computer-readable storage medium comprising instructions stored thereon that, when executed by at least one processor, are configured to cause a computing system to perform the method of any of Examples 1-15.

Example 17. An apparatus comprising means for performing the method of any of Examples 1-15.

Example 18. An apparatus comprising at least one processor and at least one memory including computer program code, the at least one memory and the computer program code configured to, with the at least one processor, cause the apparatus at least to perform the method of any of Examples 1-15.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
identifying a first vertex as a vertex to be compressed;
identifying a plurality of neighboring vertices as compressed vertices;
predicting a position of a second vertex, the second vertex being proximate to one of the plurality of neighboring vertices;
predicting a position of a third vertex, the third vertex being proximate to the first vertex;
generating a correction variable based on the position of the second vertex and a position of the one of the plurality of neighboring vertices; and
determining a position of the first vertex based on the position of the third vertex and the correction variable.

2. The method of claim 1, wherein the position of the first vertex is predicted based on edges of geometric data being compressed.

3. The method of claim 1, wherein the position of the first vertex is determined using a Quad Tromino prediction based on edges.

4. The method of claim 1, wherein the position of the first vertex is predicted based on parallelograms of geometric data being compressed.

5. The method of claim 1, wherein the position of the first vertex is determined using a Quad Tromino prediction based on parallelograms.

6. The method of claim 1, further comprising:
predicting a position of a fourth vertex, the fourth vertex being proximate to a second one of the plurality of neighboring vertices;
generating a second correction variable based on the position of the fourth vertex and a position of the second one of the plurality of neighboring vertices; and
determining a second position of the first vertex based on the position of the third vertex and the second correction variable.

7. The method of claim 6, further comprising:
determining a third position of the first vertex based on the position of the first vertex and the second position of the first vertex.

8. The method of claim 1 further comprising compressing geometric data including compressing the first vertex, wherein the first vertex is added to the plurality of neighboring vertices.

9. The method of claim 1, further comprising:
modifying the determined position of the first vertex based on a geometric property of at least one of the plurality of neighboring vertices, wherein the geometric property includes a curvature or a spacing of grid lines.

10. The method of claim 1, further comprising:
modifying the determined position of the first vertex by applying the correction variable.

11. The method of claim 1, further comprising:
modifying the determined position of the first vertex based on an average of multiple predictions derived from different neighboring vertex combinations.

12. The method of claim 1, further comprising:
modifying the determined position of the first vertex based on an additional set of neighboring vertices, where the additional set of neighboring vertices includes previously processed vertices not utilized in the determination of the position of the first vertex.

13. The method of claim 1, wherein determining the position of the first vertex includes averaging a plurality of predicted positions.

14. A non-transitory computer-readable storage medium comprising instructions stored thereon that, when executed by at least one processor, are configured to cause a computing system to:
identify a first vertex as a vertex to be compressed;
identify a plurality of neighboring vertices as compressed vertices;
predict a position of a second vertex, the second vertex being proximate to one of the plurality of neighboring vertices;
predict a position of a third vertex, the third vertex being proximate to the first vertex;
generate a correction variable based on the position of the second vertex and a position of the one of the plurality of neighboring vertices; and
determine a position of the first vertex based on the position of the third vertex and the correction variable.

15. The non-transitory computer-readable storage medium of claim 14, wherein the position of the first vertex is determined using a Quad Tromino prediction based on edges.

16. The non-transitory computer-readable storage medium of claim 14, wherein the position of the first vertex is determined using a Quad Tromino prediction based on parallelograms.

17. The non-transitory computer-readable storage medium of claim 14, wherein the instructions are further configured to cause the computing system to:
modify the determined position of the first vertex based on a geometric property of at least one of the plurality of neighboring vertices, wherein the geometric property includes a curvature or a spacing of grid lines.

18. The non-transitory computer-readable storage medium of claim 14, wherein the instructions are further configured to cause the computing system to:
modify the determined position of the first vertex by applying the correction variable.

19. The non-transitory computer-readable storage medium of claim 14, wherein the instructions are further configured to cause the computing system to:
modify the determined position of the first vertex based on an average of multiple predictions derived from different neighboring vertex combinations.

20. An apparatus comprising at least one processor and at least one memory including computer program code, the at least one memory and the computer program code configured to, with the at least one processor, cause the apparatus to:
identify a first vertex as a vertex to be compressed;
identify a plurality of neighboring vertices as compressed vertices;
predict a position of a second vertex, the second vertex being proximate to one of the plurality of neighboring vertices;
predict a position of a third vertex, the third vertex being proximate to the first vertex;
generate a correction variable based on the position of the second vertex and a position of the one of the plurality of neighboring vertices; and
determine a position of the first vertex based on the position of the third vertex and the correction variable.
